(19) United States
(12) Patent Application Publication
(10) Pub. No.: US 2026/0066469 A1
(43) Pub. Date: Mar. 5, 2026

(54) SECONDARY BATTERY

(71) Applicant: SAMSUNG SDI CO., LTD., Yongin-si (KR)

(72) Inventor: Min Hyung GUEN, Yongin-si (KR)

(21) Appl. No.: 19/089,341

(22) Filed: Mar. 25, 2025

(30) Foreign Application Priority Data
Sep. 4, 2024 (KR) 10-2024-0119775

(51) Int. Cl. H01M 50/463; H01M 10/04; H01M 50/434

(52) U.S. Cl. CPC H01M 50/463; H01M 10/0459; H01M 50/434

(57) ABSTRACT

A secondary battery includes an electrode stack having a separator, the separator including a first separator region, a second separator region, a third separator region, and a fourth separator region, a first negative electrode plate between the first separator region and the second separator region, and a first positive electrode plate between the third separator region and the fourth separator region, an insulating tape on a periphery of the electrode stack, and a case receiving the electrode stack and the insulating tape, wherein one side of the second separator region contacts one side of the third separator region.

### CROSS-REFERENCE TO THE RELATED APPLICATION

The present application claims priority to and the benefit of Korean Patent Application No. 10-2024-0119775, filed on Sep. 4, 2024, in the Korean Intellectual Property Office, the entire disclosure of which is incorporated herein by reference.

### BACKGROUND

### 1. Field

Embodiments of the present disclosure relate to a secondary battery.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

Embodiments include a secondary battery, including an electrode stack having a separator, the separator including a first separator region, a second separator region, a third separator region, and a fourth separator region, a first negative electrode plate between the first separator region and the second separator region, and a first positive electrode plate between the third separator region and the fourth separator region, an insulating tape on a periphery of the electrode stack, and a case receiving the electrode stack and the insulating tape, wherein one side of the second separator region contacts one side of the third separator region.

The separator may further include a first bent region interconnecting the first separator region and the second separator region, a second bent region interconnecting the second separator region and the third separator region, and a third bent region interconnecting the third separator region and the fourth separator region.

The second separator region may further have a plurality of second through-holes, the third separator region may further have a plurality of third through-holes, and the plurality of second through-holes and the plurality of third through-holes do not overlap each other.

Each of the plurality of second through-holes and each of the plurality of third through-holes has a diameter of 100 μm to 1000 μm.

The second separator region may further have a second ceramic coating region, and the third separator region may further have a third ceramic coating region.

The second ceramic coating region may further have a second opening through which the second separator region is exposed, the second opening not being coated, and the third ceramic coating region may further have a third opening through which the third separator region is exposed, the third opening not being coated.

The second opening and the third opening may each have a diameter of 100 μm to 1000 μm.

The separator may further include a fifth separator region, a sixth separator region, and a seventh separator region, and the electrode stack may further include a second negative electrode plate between the fourth separator region and the fifth separator region, a second positive electrode plate between the fifth separator region and the sixth separator region, and a third negative electrode plate between the sixth separator region and the seventh separator region.

The separator may further include a fourth bent region interconnecting the fourth separator region and the fifth separator region, a fifth bent region interconnecting the fifth separator region and the sixth separator region, and a sixth bent region interconnecting the sixth separator region and the seventh separator region.

The separator may further include an eighth separator region, a ninth separator region, and a tenth separator region, the electrode stack further comprises a third positive electrode plate between the seventh separator region and the eighth separator region and a fourth negative electrode plate between the ninth separator region and the tenth separator region, and one side of the eighth separator region contacts one side of the ninth separator region.

The separator may further include a seventh bent region interconnecting the seventh separator region with the eighth separator region, an eighth bent region interconnecting the eighth separator region with the ninth separator region, and a ninth bent region interconnecting the ninth separator region with the tenth separator region.

The eighth separator region may further have a plurality of eighth through-holes, the ninth separator region may further have a plurality of ninth through-holes, and the plurality of eighth through-holes and the plurality of ninth through-holes do not overlap each other.

Each of the plurality of eighth through-holes and each of the plurality of ninth through-holes may have a diameter of 100 μm to 1000 μm.

The eighth separator region may further include an eighth ceramic coating region, and the ninth separator region may further include a ninth ceramic coating region.

The eighth ceramic coating region may further have an eighth opening through which the eighth separator region is exposed, the eighth opening not being coated, and the ninth ceramic coating region may further have a ninth opening through which the ninth separator region is exposed, the ninth opening not being coated.

The eighth opening and the ninth opening may each have a diameter of 100 μm to 1000 μm.

Embodiments include a secondary battery, including an electrode stack including a separator, the separator including a first separator region, a second separator region, a third separator region, a fourth separator region, and a fifth separator region, a first negative electrode plate between the first separator region and the second separator region, and a first positive electrode plate between the fourth separator region and the fifth separator region, an insulating tape on a periphery of the electrode stack, and a case receiving the electrode stack and the insulating tape, wherein one side of the second separator region contacts one side of the third separator region, and the other side of the third separator region contacts one side of the fourth separator region.

The separator may further include a sixth separator region, a seventh separator region, and an eighth separator region, and the electrode stack may further include a second negative electrode plate between the fifth separator region and the sixth separator region, a second positive electrode plate between the sixth separator region and the seventh separator region, and a third negative electrode plate between the seventh separator region and the eighth separator region.

The separator may further include a ninth separator region, a tenth separator region, an eleventh separator region, and a twelfth separator region, the electrode stack may further include a third positive electrode plate between the eighth separator region and the ninth separator region and a fourth negative electrode plate between the eleventh separator region and the twelfth separator region, and one side of the ninth separator region contacts one side of the tenth separator region, and the other side of the tenth separator region contacts one side of the eleventh separator region.

These and other aspects and features of the present disclosure will be described in or will be apparent from the following description of embodiments of the present disclosure.

### BRIEF DESCRIPTION OF THE DRAWINGS

Features will become apparent to those of ordinary skill in the art by describing in detail exemplary embodiments with reference to the attached drawings, in which:

FIGS. 1 and 2 are a perspective view and a sectional view, respectively, showing a prismatic battery according to one or more embodiments of the present disclosure;

FIG. 3 is a sectional view showing an electrode stack of the prismatic battery according to the embodiment of FIGS. 1 and 2;

FIG. 4 is a sectional view showing an electrode stack according to one or more embodiments of the present disclosure, penetrated by a needle-shaped structure;

FIG. 5 is a sectional view showing an electrode stack of a prismatic battery according to one or more other embodiments of the present disclosure;

FIGS. 6 to 8 are sectional views showing a part of a separator of the prismatic battery according to the embodiment of FIG. 5;

FIG. 9 is a perspective view illustrating a battery module according to one or more embodiments of the present disclosure.

FIGS. 10 and 11 are a perspective view and an exploded perspective view, respectively, showing a pouch type battery according to one or more embodiments of the present disclosure;

FIGS. 12 and 13 are perspective views showing a battery pack including the exemplary cylindrical secondary battery according to one or more embodiments of the present disclosure; and

FIGS. 14 and 15 are perspective and side views showing a vehicle including an exemplary battery pack according to one or more embodiments of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her embodiments in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in this specification are for describing embodiments of the present disclosure and are not intended to limit the present disclosure.

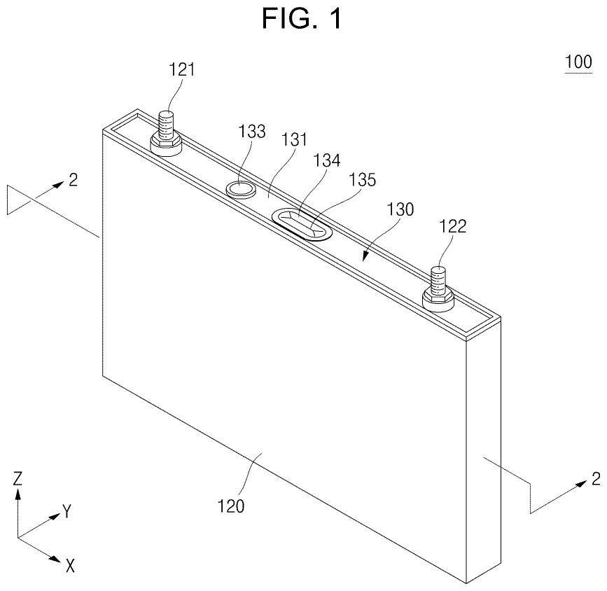

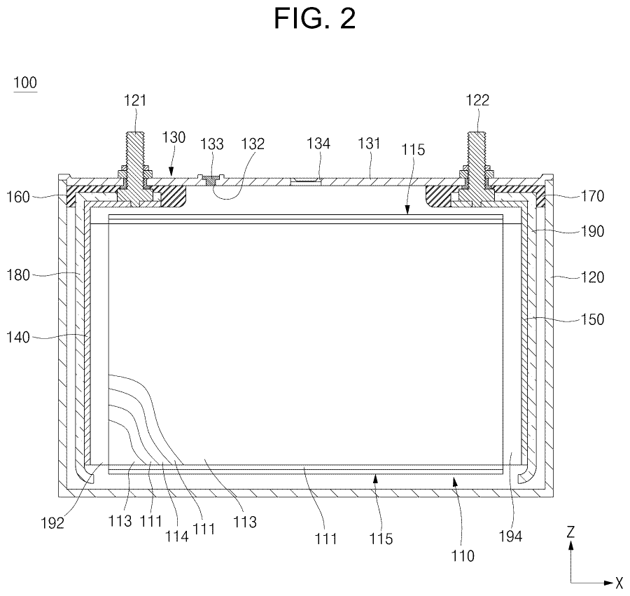

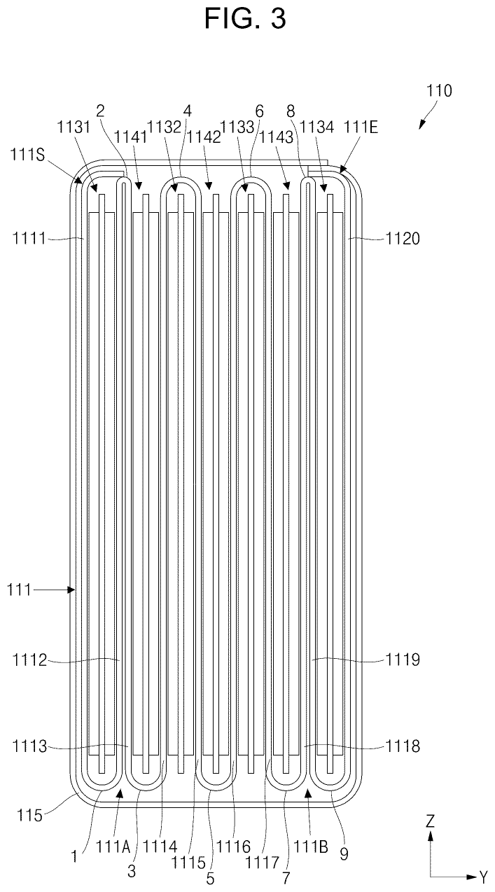

FIGS. 1 and 2 are a perspective view and a sectional view, respectively, showing a prismatic battery 100 according to one or more embodiments of the present disclosure. FIG. 2 is a sectional view taken along line 2-2 of FIG. 1. FIG. 3 is a sectional view showing an electrode stack 110 of the prismatic battery 100 according to the embodiment of the present disclosure.

In the example shown in FIGS. 1 and 2, the secondary battery 100 according to an embodiment of the present disclosure may include an electrode stack 110, a case 120 in which the electrode stack 110 is received, and a cap assembly 130 coupled to an opening of the case 120.

The electrode stack 110 may include a separator 111 that is bent, for example, in a Z or S shape and has a plurality of staggered bent regions, a first electrode plate 113 disposed on one side of the separator 111, and a second electrode plate 114 disposed on the other side of the separator 111. In one or more embodiments, the first electrode plate 113 may be disposed on one side of the separator 111 extending in a vertical direction, the second electrode plate 114 may be disposed on the other side of the separator 111 extending in a horizontal direction, and the bent regions may be provided at an upper end and a lower end of the separator 111 interposed between the first and second electrode plates 112 and 113, respectively. As such, the separator 111 may be bent a number of times (e.g., in a Z or S shape), and the first electrode plate 113 and the second electrode plates 114, which have opposite polarities, may be located on one side and the other side of the bent separator 111, respectively, so as to intersect each other. The electrode stack 110 may include or be referred to as a stack, a Z stack, an electrode assembly, an electrode group, or a jelly-roll.

In one or more embodiments, the separator 111 may have, for example, six bent regions on an upper side and five bent regions on a lower side, but the number and location of bent regions may vary. A region provided on one side of the separator 111 may be defined as a separator start region 111S, and a region provided on the other side of the separator 111 may be defined as a separator end region 111E. In one or more embodiments, a part of the separator start region 111S may be bent in an inward direction (e.g., Y-axis direction), and a part of the separator end region 111E may be bent in the inward direction (e.g., −Y-axis direction).

In one or more embodiments, the separator 111 may include or be referred to as a separation membrane or an isolation membrane. In one or more embodiments, the separator 111 may include polyethylene, polypropylene, and a porous copolymer of polyethylene and polypropylene. In one or more embodiments, the surface of the separator 111 may be coated with ceramic for improved thermal performance.

In one or more embodiments, the width of the separator 111 may be greater than the width of each of the first electrode plate 113 and the second electrode plate 114 to prevent an electrical short circuit between the first electrode plate 113 and the second electrode plate 114.

In one or more embodiments, the first electrode plate 113 may include a first active material layer, a first mixture layer, or a negative electrode active material layer coated on one surface or both surfaces of a first substrate made of a thin conductive metal sheet, such as copper or nickel foil or mesh. In one or more embodiments, the first electrode plate 113 may function as a negative electrode (or negative electrode plate). In one or more embodiments, the first substrate may further include a first substrate tab 192 extending outward by a certain length without the first active material layer formed thereon, which may be welded to a first current collector 140 as will be described below.

In one or more embodiments, the second electrode plate 114 may include a second active material layer, a second mixture layer, or a positive electrode active material layer coated on one surface or both surfaces of a second substrate made of a highly conductive thin metal sheet, such as aluminum foil or mesh. In one or more embodiments, the second electrode plate 114 may function as a positive electrode (or positive electrode plate). In one or more embodiments, the second substrate may further include a second substrate tab 194 extending outward by a certain length without the second active material layer formed thereon, which may be welded to a second current collector 150 as will be described below.

An insulating tape 115 may wrap around the outermost side of the electrode stack 110 to prevent loosening of the electrode stack 110. The insulating tape 115 may include an adhesive member coated on an inner surface, which may be adhered to the separator 111, the first electrode plate 113, and/or the second electrode plate 114. In one or more embodiments, the insulating tape 115 may be selected considering affinity for electrolytes, absorbency, and swelling properties. In one or more embodiments, the insulating tape 115 may include thermoplastic polyurethane (TPU), polyethylene (PE), or polypropylene (PP). TPU has high affinity for electrolytes, good absorbency, and good swelling properties. PE is inexpensive and has good processability, but low affinity for electrolytes may necessitate surface treatment. PP is inexpensive and has good processability, similarly to PE, but has lower affinity for electrolytes.

The case 120 may form the overall appearance of the secondary battery 100 and may be made of a conductive metal, such as aluminum, an aluminum alloy, nickel-plated steel, or stainless steel. The case 120 may provide a space in which the electrode stack 110 is received. In one or more embodiments, the case 120 may be in the form of a flat hexahedron with an open top.

The cap assembly 130 may include a cap plate 131 that covers the opening of the case 120. The material of the cap plate 131 may be similar or identical to the material of the case 120. Negative and positive electrode terminals 121 and 122 electrically connected to the negative electrode 113 and the positive electrode 114, respectively, may be installed so as to protrude outward through the cap plate 131.

The outer circumferential surfaces of upper posts of the negative and positive electrode terminals 121 and 122 protruding outward from the cap plate 131 may be threaded and may be secured to the cap plate 131 with nuts.

However, the negative and positive electrode terminals 121 and 122 may be riveted or welded to the cap plate 131.

The cap plate 131 may be a thin plate that is coupled to the opening of the case 120, the cap plate 131 may have formed therein an electrolyte inlet 132 in which a sealing stopper 133 may be installed, and a vent portion 134 having a notch 135 may be installed at the cap plate 131. In some examples, the vent portion 134 may plug a vent hole provided in the cap plate 131. In some examples, the vent portion 134 may be coupled or welded to a peripheral region of the vent hole (region of the cap plate).

The negative and positive electrode terminals 121 and 122 may be electrically connected to a current collector including first and second current collectors 140 and 150 (hereinafter referred to as negative and positive electrode current collectors) welded to the first substrate tab 192 and the second substrate tab 194, respectively.

For example, the negative and positive electrode terminals 121 and 122 may be welded to the negative and positive electrode current collectors 140 and 150, respectively. However, the present disclosure is not limited thereto, and the negative and positive electrode terminals 121 and 122 and the negative and positive electrode current collectors 140 and 150 may be integrally coupled to each other.

An insulating member may be installed between the electrode stack 110 and the cap plate 131. The insulating member may include first and second lower insulating members 160 and 170, and each of the first and second lower insulating members 160 and 170 may be installed between the electrode stack 110 and the cap plate 131.

In accordance with the present embodiment, one end of a separating member, which may be installed opposite one side surface of the electrode stack 110, may be installed between the insulating member and the negative or positive electrode terminal 121 or 122.

In one or more embodiments, the separating member may include first and second separating members 180 and 190.

Consequently, one end of each of the first and second separating members 180 and 190, which may be installed opposite one side surface of the electrode stack 110, may be installed between a corresponding one of the first and second lower insulating members 160 and 170 and a corresponding one of the negative and positive electrode terminals 121 and 122.

As a result, each of the negative and positive electrode terminals 121 and 122 welded to the negative and positive electrode current collectors 140 and 150 may be coupled to a corresponding one of the first and second lower insulating members 160 and 170 and one end of a corresponding one of the first and second separating members 180 and 190.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c} D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b} G_{b}O₂ (0.90≤a≤1.8, 0.001≤b≤0.1); LiₐMn₂G_{b}O₄ (0.90≤a≤1.8, 0.001≤b≤0.1); LiₐMn_{1-g} G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but the material may vary.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x≤2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based heavy antibody or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

An electrode stack 110 according to one or more embodiments of the present disclosure will be described in more detail with reference to FIG. 3. For clear understanding of the present disclosure, the first electrode plate or the negative electrode 113 is referred to as a first negative electrode plate 1131, a second negative electrode plate 1132, a third negative electrode plate 1133, and the like, and the second electrode plate or the positive electrode 114 is referred to as a first positive electrode plate 1141, a second positive electrode plate 1142, a third positive electrode plate 1143, and the like. The separator 111 will also be described in detail as a number of regions. While components of the electrode stack 110 are shown loosely spaced apart from each other in FIG. 3 for clear understanding of the present disclosure, it will be understood by those skilled in the art that in practice, the components of the electrode stack 110 are in compactly tight contact with each other.

The separator 111, which is one component of the electrode stack 110, may include a first separator region 1111, a second separator region 1112, a third separator region 1113, and a fourth separator region 1114 arranged in a direction from one side to the other (e.g., Y-axis direction). The electrode stack 110 may include a first negative electrode plate 1131 (or first positive electrode plate 1141) interposed between the first separator region 1111 and the second separator region 1112 and a first positive electrode plate 1141 (or first positive electrode plate 1131) interposed between the third separator region 1113 and the fourth separator region 1114.

In one or more embodiments, one side (e.g., right side) of the second separator region 1112 and one side (e.g., left side) of the third separator region 1113 may be in direct contact with each other. In other embodiments, the entirety of one side surface of the second separator region 1112 and the entirety of one side surface of the third separator region 1113 may be in direct contact with each other. In other embodiments, no negative electrode or positive electrode plate may be interposed between the second separator region 1112 and the third separator region 1113.

In one or more embodiments, the first separator region 1111 and the second separator region 1112 may be connected to each other via a lower first bent region 1, the second separator region 1112 and the third separator region 1113 may be connected to each other via an upper second bent region 2, and the third separator region 1113 and the fourth separator region 1114 may be connected to each other via a lower third bent region 3.

In one or more embodiments, the separator 111 may further include a fifth separator region 1115, a sixth separator region 1116, and a seventh separator region 1117. The electrode stack 110 may further include a second negative electrode plate 1132 (or second positive electrode plate 1142) between the fourth separator region 1114 and the fifth separator region 1115, a second positive electrode plate 1142 (or second negative electrode plate 1132) between the fifth separator region 1115 and the sixth separator region 1116, and a third negative electrode plate 1133 (or third positive electrode plate 1143) between the sixth separator region 1116 and the seventh separator region 1117.

In one or more embodiments, the fourth separator region 1114 and the fifth separator region 1115 may be connected to each other via an upper fourth bent region 4, the fifth separator region 1115 and the sixth separator region 1116 may be connected to each other via a lower fifth bent region 5, and the sixth separator region 1116 and the seventh separator region 1117 may be connected to each other via an upper sixth bent region 6.

In one or more embodiments, the separator 111 may further include an eighth separator region 1118, a ninth separator region 1119, and a tenth separator region 1120. The electrode stack 110 may further include a third positive electrode plate 1143 (or third negative electrode plate 1133) between the seventh separator region 1117 and the eighth separator region 1118 and a fourth negative electrode plate 1134 (or fourth positive electrode plate 1144) between the ninth separator region 1119 and the tenth separator region 1120.

In one or more embodiments, one side (e.g., right side) of the eighth separator region 1118 and one side (e.g., left side) of the ninth separator region 1119 may be in contact with each other. In other embodiments, the entirety of one side surface of the eighth separator region 1118 and the entirety of one side surface of the ninth separator region 1119 may be in direct contact with each other. In other embodiments, no negative electrode or positive electrode plate may be interposed between the eighth separator region 1118 and the ninth separator region 1119.

In some examples, the seventh separator region 1117 and the eighth separator region 1118 may be connected to each other via a lower seventh bent region 7, the eighth separator region 1118 and the ninth separator region 1119 may be connected to each other via an upper eighth bent region 8, and the ninth separator region 1119 and the tenth separator region 1120 may be connected to each other via a lower ninth bent region 9.

As such, the electrode stack 110 may include a separator first dual structure 111A interposed between the first negative electrode plate 1131 and the first positive electrode plate 1141, which are a start part of the stack, and a separator second dual structure 111B interposed between the third positive electrode plate 1143 and the fourth negative electrode plate 1134, which are an end part of the stack. Thus, for example, if a needle-shaped structure penetrates the electrode stack 110, the separator first and second dual structures 111A and 111B may inhibit short circuit in the electrode stack 110, improve insulation, and delay the rate of short circuit.

Although FIG. 3 shows that five electrode plates and four separator regions are interposed between the separator first dual structure 111A and the separator second dual structure 111B, this is only an example, and the number of electrode plates and the number of separator regions may be increased or decreased.

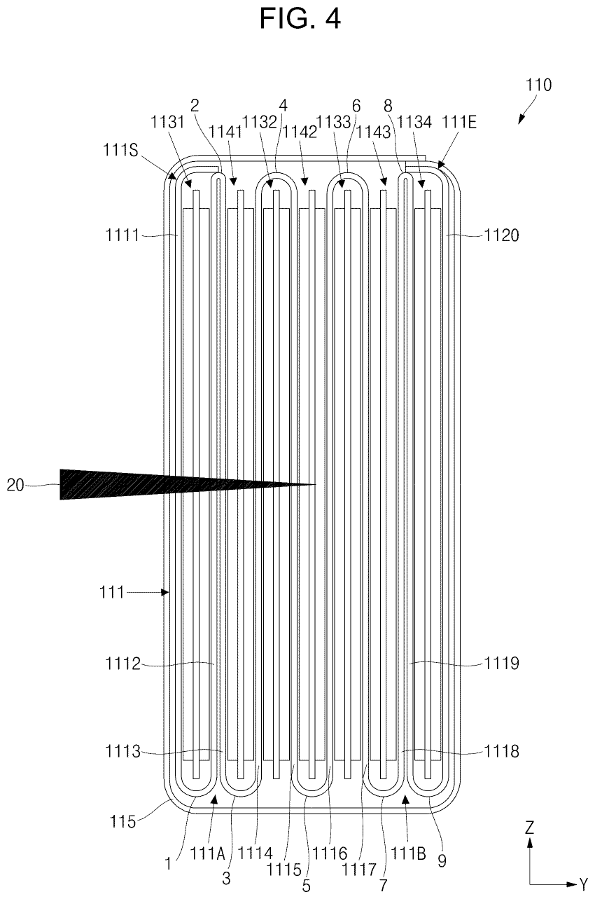

FIG. 4 is a sectional view showing an electrode stack 110 according to one or more embodiments of the present disclosure, penetrated by a needle-shaped structure 20. In the example shown in FIG. 4, the conductive needle-shaped structure 20 may penetrate the case and the electrode stack 110. At this time, a short circuit in the electrode stack 110 may be inhibited, insulation may be improved, and the rate of short circuit may be delayed by the separator first dual structure 111A, i.e., the second separator region 1112 and the third separator region 1113 interposed between the first negative electrode plate 1131 and the first positive electrode plate 1141, despite penetration of the needle-shaped structure 20.

If the needle-shaped structure 20 penetrates the electrode stack 110 in the opposite direction, a short circuit in the electrode stack 110 may also be inhibited, insulation may be improved, and the rate of short circuit may be delayed by the second dual structure 111B, i.e., the eighth separator region 1118 and the ninth separator region 1119 between the third positive electrode plate 1143 and the fourth negative electrode plate 1134, despite penetration of the needle-shaped structure 20.

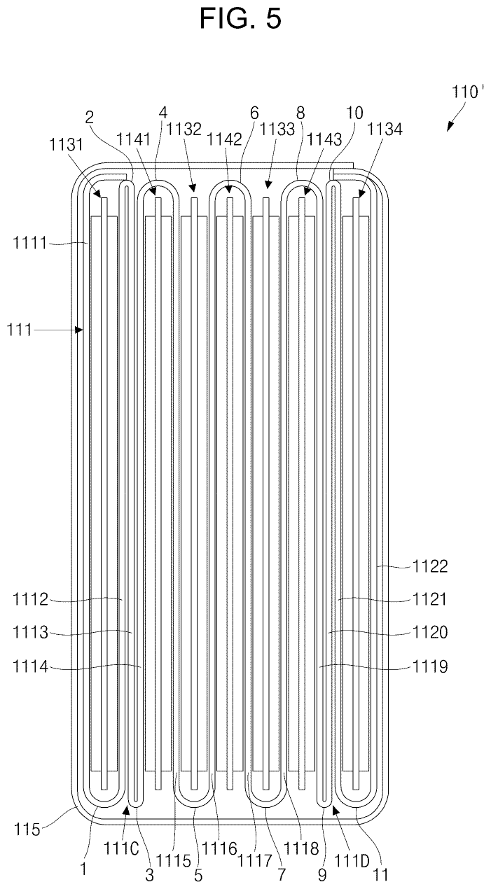

FIG. 5 is a sectional view showing an electrode stack 110′ of a prismatic battery according to another embodiment of the present disclosure. In the example shown in FIG. 5, the electrode stack 110′ may be similar to the electrode stack 110 shown in FIG. 3 except that the electrode stack 110′ includes a separator first triple structure 111C including a second separator region 1112, a third separator region 1113, and a fourth separator region 1114 interposed between a first negative electrode plate 1131 and a first positive electrode plate 1141 and a separator second triple structure 111D including a ninth separator region 1119, a tenth separator region 1120, and an eleventh separator region 1121 interposed between a third positive electrode plate 1143 and a fourth negative electrode plate 1134.

A separator 111 may include a first separator region 1111, a second separator region 1112, a third separator region 1113, a fourth separator region 1114, and a fifth separator region 1115 arranged in the horizontal direction (e.g., Y-axis direction). In one or more embodiments, the electrode stack 110′ may include a first negative electrode plate 1131 between the first separator region 1111 and the second separator region 1112 and a first positive electrode plate 1141 between the fourth separator region 1114 and the fifth separator region 1115.

In one or more embodiments, the right side of the second separator region 1112 and the left side of the third separator region 1113 may be in contact with each other, and the right side of the third separator region 1113 and the left side of the fourth separator region 1114 may be in direct contact with each other. In other embodiments, no negative electrode or positive electrode plate may be interposed between the second separator region 1112 and the third separator region 1113, and no negative electrode or positive electrode plate may be interposed between the third separator region 1113 and the fourth separator region 1114. In other embodiments, the second separator region 1112, the third separator region 1113, and the fourth separator region 1114 may be interposed between the first negative electrode plate 1131 and the first positive electrode plate 1141. In other embodiments, the separator first triple structure 111C may be interposed between the first negative electrode plate 1131 and the first positive electrode plate 1141.

In one or more embodiments, the first separator region 1111 and the second separator region 1112 may be connected to each other via a lower first bent region 1, the second separator region 1112 and the third separator region 1113 may be connected to each other via an upper second bent region 2, the third separator region 1113 and the fourth separator region 1114 may be connected to each other via a lower third bent region 3, and the fourth separator region 1114 and the fifth separator region 1115 may be connected to each other via an upper fourth bent region 4.

In one or more embodiments, the separator 111 may further include a sixth separator region 1116, a seventh separator region 1117, and an eighth separator region 1118. The electrode stack 110′ may further include a second negative electrode plate 1132 (or second positive electrode plate 1142) between the fifth separator region 1115 and the sixth separator region 1116, a second positive electrode plate 1142 (or second negative electrode plate 1132) between the sixth separator region 1116 and the seventh separator region 1117, and a third negative electrode plate 1133 (or third positive electrode plate 1143) between the seventh separator region 1117 and the eighth separator region 1118.

In one or more embodiments, the fifth separator region 1115 and the sixth separator region 1116 may be connected to each other via a lower fifth bent region 5, the sixth separator region 1116 and the seventh separator region 1117 may be connected to each other via an upper sixth bent region 6, and the seventh separator region 1117 and the eighth separator region 1118 may be connected to each other via a lower seventh bent region 7.

In one or more embodiments, the separator 111 may further include a ninth separator region 1119, a tenth separator region 1120, an eleventh separator region 1121, and a twelfth separator region 1122. The electrode stack 110′ may further include a third positive electrode plate 1143 (or third negative electrode plate 1133) between the eighth separator region 1118 and the ninth separator region 1119 and a fourth negative electrode plate 1134 (or fourth positive electrode plate 1144) between the eleventh separator region 1121 and the twelfth separator region 1122.

In one or more embodiments, the right side of the ninth separator region 1119 and the left side of the tenth separator region 1120 may be in contact with each other, and the right side of the tenth separator region 1120 and the left side of the eleventh separator region 1121 may be in contact with each other. In other embodiments, no negative electrode or positive electrode plate may be interposed between the ninth separator region 1119 and the tenth separator region 1120, and no negative electrode or positive electrode plate may be interposed between the tenth separator region 1120 and the eleventh separator region 1121. In other embodiments, the ninth separator region 1119, the tenth separator region 1120, and the eleventh separator region 1121 may be interposed between the third positive electrode plate 1143 and the fourth negative electrode plate 1134. In other embodiments, the separator second triple structure 111D may be interposed between the third positive electrode plate 1143 and the fourth negative electrode plate 1134.

In some examples, the ninth separator region 1119 and the tenth separator region 1120 may be connected to each other via a lower ninth bent region 9, the tenth separator region 1120 and the eleventh separator region 1121 may be connected to each other via an upper tenth bent region 10, and the eleventh separator region 1121 and the twelfth separator region 1122 may be connected to each other via a lower eleventh bent region 11.

As such, the electrode stack 110′ may include a separator first triple structure 111C interposed between the first negative electrode plate 1131 and the first positive electrode plate 1141, which are a start part of the stack, and a separator second triple structure 111D interposed between the third positive electrode plate 1143 and the fourth negative electrode plate 1134, which are an end part of the stack. As such, for example, if a needle-shaped structure penetrates the electrode stack 110′, the separator first and second triple structures 111C and 111D may inhibit short circuit in the electrode stack 110, improve insulation, and delay the rate of short circuit.

Although FIG. 5 shows that five electrode plates and four separator regions are interposed between the separator first triple structure 111C and the separator second triple structure 111D, this is only an example, and the number of electrode plates and the number of separator regions may be increased or decreased.

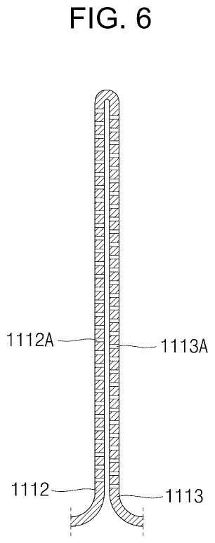

FIGS. 6 to 8 are sectional views showing a part of the separator 111 of the prismatic battery 100 according to one or more embodiments of the present disclosure. The separator 111 shown in FIGS. 6 to 8 may be associated with FIG. 3 or may be associated with FIG. 5. In the example shown in FIGS. 6 to 8, the separator 111 may have two or three overlapping layers without intervention of a negative electrode plate and/or a positive electrode plate, which may reduce the conductivity of lithium ions.

In one or more embodiments, as shown in FIG. 6, the second separator region 1112 may further include a plurality of second through-holes 1112A, the third separator region 1113 may further include a plurality of third through-holes 1113A, and the second and third through-holes 1112A and 1113A may not overlap each other. In one or more embodiments, the second and third through-holes 1112A and 1113A may have a diameter of from about 100 μm to about 1000 μm.

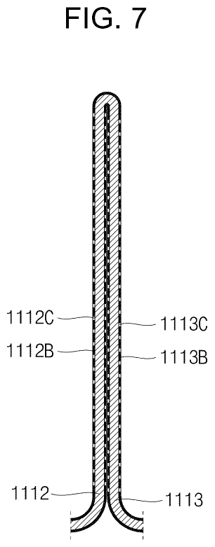

In one or more embodiments, as shown in FIG. 7, the second separator region 1112 may further include a second ceramic coating region 1112B, and the third separator region 1113 may further include a third ceramic coating region 1113B. In one or more embodiments, the second ceramic coating region 1112B may further include a second opening 1112C which is not coated and through which the second separator region 1112 is exposed, and the third ceramic coating region 1113B may further include a third opening 1113C which is not coated and through which the third separator region 1113 is exposed. In one or more embodiments, the second and third openings 1112C and 1113C may have a diameter of about 100 μm to about 1000 μm. In one or more embodiments, the second and third openings 1112C and 1113C may not overlap each other.

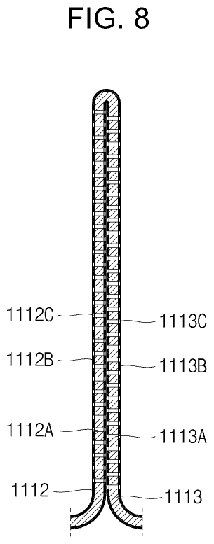

In one or more embodiments, the embodiments of FIGS. 6 and 7 may be combined with each other, as shown in FIG. 8. For example, the second and third separator regions 1112 and 1113 may be provided with first and second through-holes 1112A and 1113A, the first and second separator regions 1112 and 1113 may be provided with first and second ceramic coating regions 1112B and 1113B, and the first and second ceramic coating regions 1112B and 1113B may be provided with first and second openings 1112C and 1113C.

The features of the second and third separator regions 1112 and 1113 may be similarly applied to the eighth and ninth separator regions 1118 and 1119. For example, the eighth separator region 1118 may have a plurality of eighth through-holes, the ninth separator region 1119 may have a plurality of ninth through-holes, and the eighth and ninth through-holes may not overlap each other. The eighth and ninth through-holes may each have a diameter of from about 100 μm to about 1000 μm. The eighth separator region 1118 may have an eighth ceramic coating region, and the ninth separator region 1119 may include a ninth ceramic coating region. The eighth ceramic coating region may have an eighth opening which is not coated and through which the eighth separator region 1118 is exposed, the ninth ceramic coating region may have a ninth opening which is not coated and through which the ninth separator region 1119 is exposed, and the eighth and ninth openings may each have a diameter of about 100 μm to about 1000 μm.

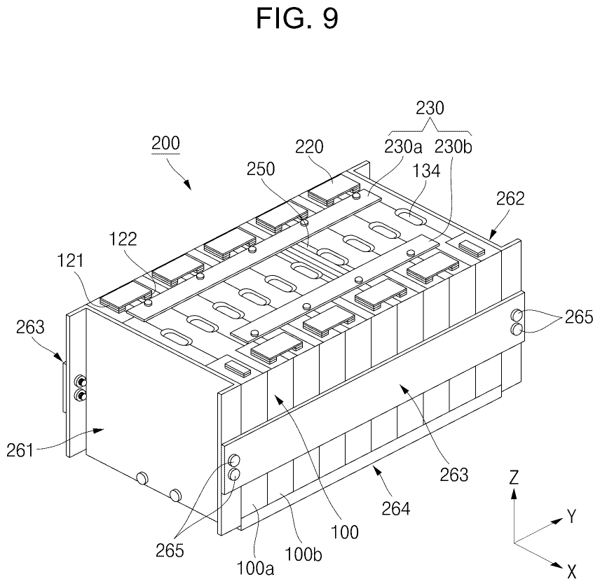

FIG. 9 is a perspective view illustrating a battery module 200 according to one or more embodiments of the present disclosure. Referring to FIG. 9, the battery module 200 according to one or more embodiments of the present disclosure includes electrode units 121 and 122, a plurality of battery cells 100 arranged in one direction (e.g., the Y-axis direction), a connection tab 220 connecting a battery cell 100a to an adjacent battery cell 100b, and a protection circuit module 230 having one end connected to the connection tab 220. The protection circuit module 230 may include a battery management system (BMS). Further, the connection tab 220 may include a body portion in contact with the electrode units 121 and 122 between the adjacent battery cells 100a and 100b and an extension portion extending from the body portion and connected to the protection circuit module 230. The connection tab 220 may be, for example, a bus bar.

Each battery cell 100 may include a battery case, an electrode assembly received (or accommodated) in the battery case, and an electrolyte. The electrode assembly and the electrolyte react electrochemically to store and release (e.g., generate) energy. Terminal parts 121 and 122 electrically connected to the connection tab 220 and a vent 134 as a discharge passage for gas generated inside the battery case may be provided on one side of (e.g., an upper side of) the battery cell 100. The terminal parts 121 and 122 of the battery cell 100 may be a positive electrode terminal 121 and a negative electrode terminal 122 having different polarities from each other, and the terminal parts 121 and 122 of the adjacent battery cells 100a and 100b may be electrically connected to each other in series or parallel by the connection tab 220, to be described in more detail below. Although a serial connection has been described as an example, various connection structures may be employed as desired or necessary. In addition, the number and arrangement of battery cells is not limited to the structure shown in FIG. 9 and may be changed as desired or necessary.

The plurality of battery cells 100 may be arranged in (e.g., may be stacked in) one direction so that the wide surfaces of the battery cells 100 face each other, and the plurality of battery cells 100 may be fixed by the housings 261, 262, 263, and 264. The housings 261, 262, 263, and 264 may include a pair of end plates 261 and 262 facing the wide surfaces of the battery cell 100 and a side plate 263 and a bottom plate 264 connecting the pair of end plates 261 and 262 to each other. The side plate 263 may support side surfaces of the battery cells 100, and the bottom plate 264 may support bottom surfaces of the battery cells 100. In addition, the pair of end plates 261 and 262, the side plate 263 and the bottom plate 264 may be connected by bolts 265 and/or any other suitable fastening members and methods known to those of ordinary skill in the art. In some examples, the bottom plate 264 may include or be referred to as a cooling plate.

The protection circuit module 230 may have electronic components and protection circuits mounted thereon and may be electrically connected to connection tabs 220, to be described in more detail later. The protection circuit module 230 includes a first protection circuit module 230a and a second protection circuit module 230b extending along the direction in which the plurality of battery cells 100 are arranged in different locations. The first protection circuit module 230a and the second protection circuit module 230b may be spaced from each other at a suitable interval (e.g., a predetermined interval) and arranged parallel to each other to be electrically connected to adjacent connection tabs 220, respectively. For example, the first protection circuit module 230a extends on one side of the upper portion of the plurality of battery cells 100 along the direction in which the plurality of battery cells 100 are arranged, and the second protection circuit module 230b extends to the other upper side of the plurality of battery cells 100 along the direction in which the plurality of battery cells 100 are arranged. The second protection circuit module 230b may be spaced from the first protection circuit module 230a at a suitable interval (e.g., a predetermined interval) with the vents 134 interposed therebetween but may be disposed parallel to the first protection circuit module 230a. As such, the two protection circuit modules are spaced from each other side-by-side along the direction in which the plurality of battery cells 100 are arranged, thereby reducing or minimizing the area of the printed circuit board (PCB) constituting the protection circuit module. By separately configuring the protection circuit module into two protection circuit modules, unnecessary protection circuit module area can be reduced or minimized. In addition, the first protection circuit module 230a and the second protection circuit module 230b may be connected to each other by a conductive connection member 250. One side of the conductive connection member 250 is connected to the first protection circuit module 230a, and the other side thereof is connected to the second protection circuit module 230b so that the two protection circuit modules 230a and 230b can be electrically connected with each other.

The connection may be performed by any one of soldering, resistance welding, laser welding, projection welding and/or any other suitable connection methods known to those of ordinary skill in the art.

In addition, the connection member 250 may be, for example, an electric wire. In addition, the connection member 250 may be made of a material having elasticity or flexibility. By the connection member 250, it may be possible to check and manage whether the voltage, temperature, and/or current of the plurality of battery cells 100 are normal. For example, the information received by the first protection circuit module from connection tabs adjacent to the first protection circuit module, such as voltage, current, and/or temperature, and the information received from connection tabs adjacent to the second protection circuit module, such as voltage, current, and/or temperature, may be integrated and managed by the protection circuit module through the connection member 250.

In addition, when a battery cell 100 swells, shocks may be absorbed by the elasticity or flexibility of the connection member 250, thereby preventing the first and second protection circuit modules 230a and 230b from being damaged.

In addition, the shape and structure of the connection member 250 may vary from the shape and structure shown in FIG. 9.

As described above, because the protection circuit module 230 is provided as the first and second protection circuit modules 230a and 230b, the area of the PCB constituting the protection circuit module can be reduced or minimized, and the space inside the battery module can be secured, which improves work efficiency by facilitating a fastening work for connecting the connection tab 220 and the protection circuit module 230 and repair work if (or when) an abnormality is detected in the battery module.

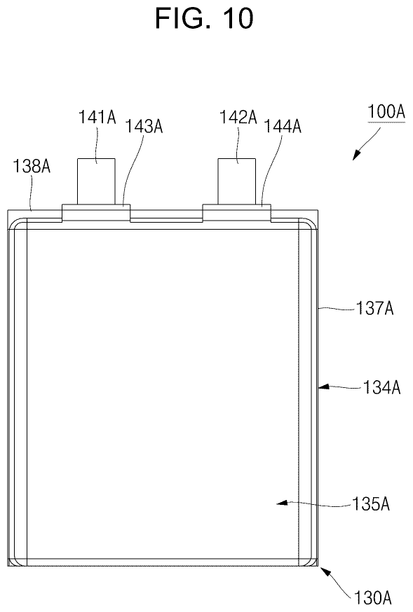

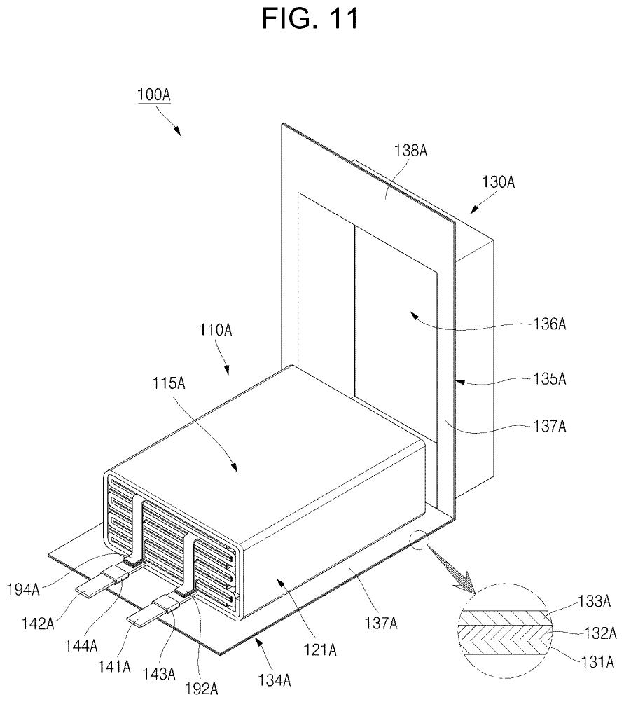

FIGS. 10 and 11 are a perspective view and an exploded perspective view, respectively, showing a pouch type battery 100A according to one or more embodiments of the present disclosure. In the example shown in FIGS. 10 and 11, the pouch type battery 100A according to the embodiment of the present disclosure may include an electrode stack 110A, an insulating tape 115A, a case 130A, a first cell tab 141A, and a second cell tab 142A. The electrode stack 110A shown in FIG. 11 may be substantially similar or identical to the electrode stack 110 shown in FIGS. 3 and 5 except that first and second substrate tabs 192A and 194A protrude and extend in the same direction. In other embodiments, the electrode stack 110A shown in FIG. 11 may also include the separator first and second dual structures described above or the separator first and second triple structures described above.

The case 130A may receive the electrode stack 110A, and the outer periphery of the electrode stack 110A may be sealed. The case 130A may include or be referred to as a cladding, pouch, can, or housing. In one or more embodiments, the case 130A may be provided in a laminate structure having, for example, a first insulating layer 131A, a metal layer 132A, and a second insulating layer 133A. Various other adhesive or functional layers may be added, but a description thereof will be omitted so as not to obscure the gist of the present disclosure.

In one or more embodiments, the case 130A may include a first case 134A and a second case 135A that is connected to the first case 134A at one end thereof and has a recess 136A of a certain depth to receive the electrode assembly 110A. In one or more embodiments, the edges of the first and second cases 134A and 135A corresponding to the outer periphery of the electrode stack 110A may be thermally fused to each other such that the electrode stack 110A can be received in the approximately pouch or pocket type case 130A.

In one or more embodiments, the case 130A may be provided as a unitary quadrangular plate, wherein the middle of the case 130A in a longitudinal direction is bent to form the first case 134A and the second case 135A. The second case 135A may be provided with a recess 136A of a certain depth in which the electrode stack 110A can be received by pressing or drawing, and a sealing region 137A for sealing with the first case 134A may be provided at the outer periphery of the recess 136A. The sealing region 137A may be provided along one side where the first case 134A and the second case 135A integrally abut each other and the remaining three sides.

In one or more embodiments, the case 130A may be made of stainless steel. Sealing of the stainless steel may be implemented by laser welding.

The first substrate tab 192A of the electrode stack 110A may be welded to the first cell tab 141A, and the second substrate tab 194A may be welded to the second cell tab 142A. In one or more embodiments, the first cell tab 141A and the second cell tab 142A may extend a certain length outward through the case 130A with a first sealing tape 143A and a second sealing tape 144A, respectively. In one or more embodiments, the region of the case 130A where the first cell tab 141A and the second cell tab 142A extend outward may be referred to as a terrace 138A. The first cell tab 141A may be made of copper and nickel, and the second cell tab 142A may be made of aluminum.

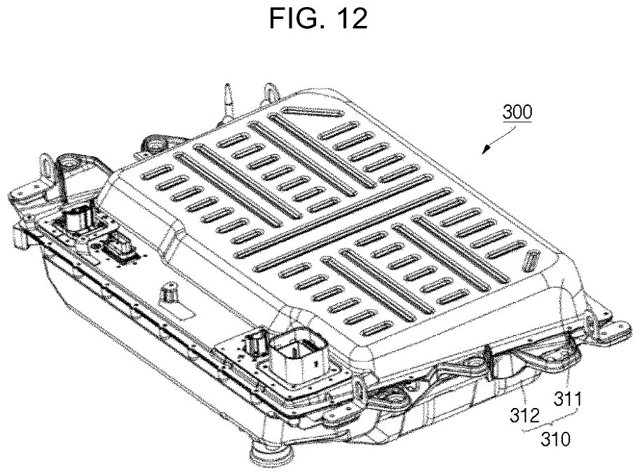

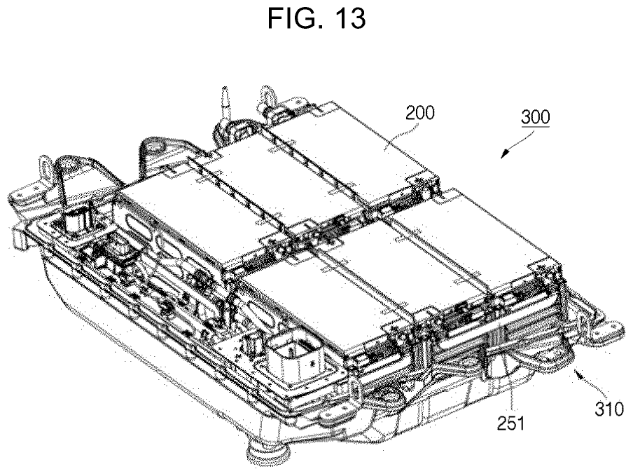

FIGS. 12 and 13 are perspective views showing a battery pack 300 including the exemplary pouch type secondary battery according to the present disclosure. Referring to FIGS. 12 and 13, the battery pack 300 may include a plurality of battery modules 200 and a housing 310 for accommodating the plurality of battery modules 200. For example, the housing 310 may include first and second housings 311 and 312 coupled in opposite directions through the plurality of battery modules 200. The plurality of battery modules 200 may be electrically connected to each other by using a bus bar 251, and the plurality of battery modules 200 may be electrically connected to each other in a series/parallel or series-parallel mixed method, thereby obtaining desired (e.g., required) electrical output. In the FIGS. 12 and 13, for convenience of illustration, parts such as bus bars, cooling units, and external terminals for electrical connection of battery cells are omitted. In one or more embodiments, battery pack 300 may be mounted in a vehicle. The vehicle may be, for example, an electric vehicle, a hybrid vehicle, or a plug-in hybrid vehicle. The vehicle may include a four-wheeled vehicle or a two-wheeled vehicle.

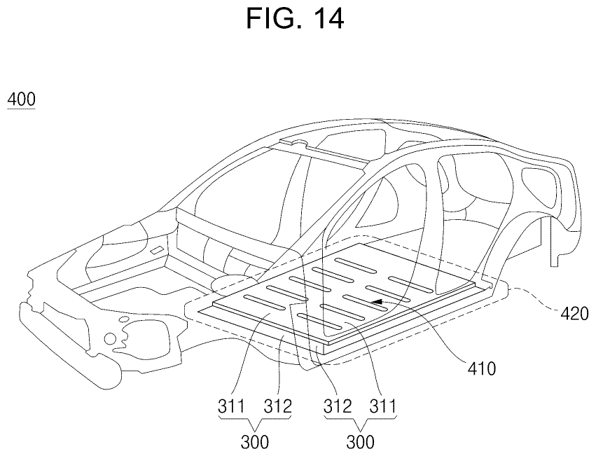

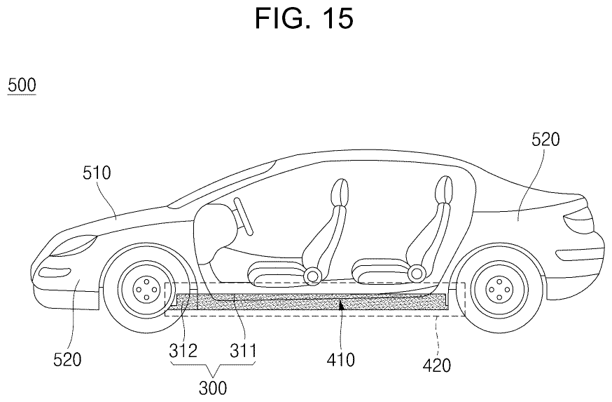

FIGS. 14 and 15 are perspective and side views showing vehicles 400 and 500 including the exemplary battery pack 300 according to the present disclosure. In FIG. 14, a battery pack 300 may include a battery pack cover 311 (may correspond to the first housing above), which is a part of a vehicle underbody 410, and a pack frame 312 (may correspond to the second housing above) disposed under the vehicle underbody 410. The pack frame 312 and the battery pack cover 311 may be integrally formed with a vehicle floor 420. The vehicle underbody 410 separates the inside and outside of a vehicle, and the pack frame 312 may be disposed outside the vehicle.

In FIG. 15, a vehicle 500 may be formed by combining additional parts, such as a hood 510 in front of the vehicle and fenders 520 respectively located in the front and rear of the vehicle to a vehicle body parts 400. The vehicle 500 may further include a vehicle floor 420, which is one of the vehicle body parts 400 including the battery pack 300 including the pack frame 312 and the battery pack cover 311.

As is apparent from the above description, according to embodiments of the present disclosure, there may be provided a secondary battery capable of inhibiting short circuit in an electrode stack, improving insulation, and delaying the rate of short circuit. For example, according to the present disclosure, a two-layer separator or a three-layer separator may be interposed between a negative electrode plate and a positive electrode plate, and therefore it is possible to inhibit internal short circuit between the negative electrode plate and the positive electrode plate due to a needle-shaped structure, if the needle-shaped structure penetrates the electrode stack, to improve insulation between the negative electrode plate and the positive electrode plate, and to delay the rate of short circuit between the negative electrode plate and the positive electrode plate.

However, other aspects and features not mentioned will be clearly understood by a person skilled in the art from the detailed description above.

Although the present disclosure has been described above with limited examples and drawings, the present disclosure is not limited thereto, and it is obvious that various modifications and variations may be made by those skilled in the art in the technical field to which the present disclosure belongs within the technical idea of the present disclosure and the equivalent scope of the patent claims described below.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of ordinary skill in the art that various changes in form and details may be made without departing from the spirit and scope of the present invention as set forth in the following claims.

What is claimed is:

1. A secondary battery, comprising:
an electrode stack comprising a separator, the separator including a first separator region, a second separator region, a third separator region, and a fourth separator region, a first negative electrode plate between the first separator region and the second separator region, and a first positive electrode plate between the third separator region and the fourth separator region;
an insulating tape on a periphery of the electrode stack; and
a case receiving the electrode stack and the insulating tape,
wherein one side of the second separator region contacts one side of the third separator region.

2. The secondary battery as claimed in claim 1, wherein the separator further comprises a first bent region interconnecting the first separator region and the second separator region, a second bent region interconnecting the second separator region and the third separator region, and a third bent region interconnecting the third separator region and the fourth separator region.

3. The secondary battery as claimed in claim 1, wherein:
the second separator region comprises a plurality of second through-holes,
the third separator region comprises a plurality of third through-holes, and
the plurality of second through-holes and the plurality of third through-holes do not overlap each other.

4. The secondary battery as claimed in claim 3, wherein each of the plurality of second through-holes and each of the plurality of third through-holes has a diameter of 100 μm to 1000 μm.

5. The secondary battery as claimed in claim 1, wherein:
the second separator region comprises a second ceramic coating region, and
the third separator region comprises a third ceramic coating region.

6. The secondary battery as claimed in claim 5, wherein:
the second ceramic coating region comprises a second opening through which the second separator region is exposed, the second opening not being coated, and
the third ceramic coating region comprises a third opening through which the third separator region is exposed, the third opening not being coated.

7. The secondary battery as claimed in claim 6, wherein the second opening and the third opening each have a diameter of 100 μm to 1000 μm.

8. The secondary battery as claimed in claim 1, wherein:
the separator comprises a fifth separator region, a sixth separator region, and a seventh separator region, and
the electrode stack comprises a second negative electrode plate between the fourth separator region and the fifth separator region, a second positive electrode plate between the fifth separator region and the sixth separator region, and a third negative electrode plate between the sixth separator region and the seventh separator region.

9. The secondary battery as claimed in claim 8, wherein the separator further comprises:
a fourth bent region interconnecting the fourth separator region and the fifth separator region,
a fifth bent region interconnecting the fifth separator region and the sixth separator region, and
a sixth bent region interconnecting the sixth separator region and the seventh separator region.

10. The secondary battery as claimed in claim 8, wherein:
the separator further comprises an eighth separator region, a ninth separator region, and a tenth separator region,
the electrode stack further comprises a third positive electrode plate between the seventh separator region and the eighth separator region and a fourth negative electrode plate between the ninth separator region and the tenth separator region, and
one side of the eighth separator region contacts one side of the ninth separator region.

11. The secondary battery as claimed in claim 10, wherein the separator further comprises:
a seventh bent region interconnecting the seventh separator region with the eighth separator region,
an eighth bent region interconnecting the eighth separator region with the ninth separator region, and
a ninth bent region interconnecting the ninth separator region with the tenth separator region.

12. The secondary battery as claimed in claim 10, wherein the eighth separator region comprises a plurality of eighth through-holes, the ninth separator region comprises a plurality of ninth through-holes, and the plurality of eighth through-holes and the plurality of ninth through-holes do not overlap each other.

13. The secondary battery as claimed in claim 12, wherein each of the plurality of eighth through-holes and each of the plurality of ninth through-holes have a diameter of 100 μm to 1000 μm.

14. The secondary battery as claimed in claim 10, wherein:
the eighth separator region comprises an eighth ceramic coating region, and
the ninth separator region comprises a ninth ceramic coating region.

15. The secondary battery as claimed in claim 14, wherein:
the eighth ceramic coating region comprises an eighth opening through which the eighth separator region is exposed, the eighth opening not being coated, and
the ninth ceramic coating region comprises a ninth opening through which the ninth separator region is exposed, the ninth opening not being coated.

16. The secondary battery as claimed in claim 15, wherein the eighth opening and the ninth opening each have a diameter of 100 μm to 1000 μm.

17. A secondary battery, comprising:
an electrode stack comprising a separator, the separator comprising a first separator region, a second separator region, a third separator region, a fourth separator region, and a fifth separator region, a first negative electrode plate between the first separator region and the second separator region, and a first positive electrode plate between the fourth separator region and the fifth separator region;
an insulating tape on a periphery of the electrode stack; and
a case receiving the electrode stack and the insulating tape,
wherein one side of the second separator region contacts one side of the third separator region, and the other side of the third separator region contacts one side of the fourth separator region.

18. The secondary battery as claimed in claim 17, wherein:
the separator comprises a sixth separator region, a seventh separator region, and an eighth separator region, and
the electrode stack comprises a second negative electrode plate between the fifth separator region and the sixth separator region, a second positive electrode plate between the sixth separator region and the seventh separator region, and a third negative electrode plate between the seventh separator region and the eighth separator region.

19. The secondary battery as claimed in claim 18, wherein:
the separator further comprises a ninth separator region, a tenth separator region, an eleventh separator region, and a twelfth separator region,
the electrode stack further comprises a third positive electrode plate between the eighth separator region and the ninth separator region and a fourth negative electrode plate between the eleventh separator region and the twelfth separator region, and
one side of the ninth separator region contacts one side of the tenth separator region, and the other side of the tenth separator region contacts one side of the eleventh separator region.
